(19) United States
(12) Patent Application Publication
(10) Pub. No.: US 2019/0146141 A1
(43) Pub. Date: May 16, 2019

(54) LAMP ASSEMBLY AND ITS FRAMELESS PANEL LIGHT

(71) Applicant: Lextar Electronics Corporation, Hsinchu (TW)

(72) Inventors: Teng-Huei HUANG, Hsinchu County (TW); I-Chang TSAO, Hsinchu City (TW); Cheng-Ta KUO, Hsinchu City (TW); Jhih-Han LIN, Hsinchu County (TW); Wei-Jung CHANG, New Taipei City (TW); Sheng-Ju CHUNG, Taoyuan City (TW); Li-Li LIU, Jiangsu Province (CN); Wen ZHOU, Hunan Province (CN)

(21) Appl. No.: 16/228,708

(22) Filed: Dec. 20, 2018

Related U.S. Application Data
(63) Continuation-in-part of application No. 15/791,429, filed on Oct. 24, 2017.

(51) Int. Cl. F21V 8/00

(52) U.S. Cl. CPC G02B 6/0061; G02B 6/0036; G02B 6/0051; G02B 6/0058; G02B 6/009

(57) ABSTRACT

A frameless panel light includes a light source module and a lamp cover having a front portion and side portions surrounding the front portion. The front and side portions define an accommodating space. The light source module is disposed in the accommodating space and includes a light source and a light guide plate. The light guide plate includes a light-transmissive substrate including first and second major surfaces and a side surface connecting the first and second major surfaces and a microstructure formed on the first major surface and including a recess and an annular groove around the recess. The annular groove has a depth greater than that of the recess. A bottom of the recess is at higher elevation than the first major surface from the second major surface. The annular groove has a protruding portion protruding from a bottom of the annular groove.

### CROSS-REFERENCE TO RELATED APPLICATION

This is a continuation-in-part (CIP) application of U.S. patent application Ser. No. 15/791,429, filed Oct. 24, 2017.

### BACKGROUND

### Technical Field

The present disclosure relates to a panel light, especially a frameless panel light and a lamp assembly with a plurality of frameless panel lights.

### Description of Related Art

Typical light emitting diode panel light has a lamp cover and a frame. The frame engages around the edge of the lamp cover and is configured to maintain structural strength of the existing light emitting diode panel light.

However, the frame which engages around the lamp cover not only decreases aesthetic quality but also results in apparent peripheral dark area because the frame covers around the edge of the lamp cover, and therefore, a light uniformity of the whole lamp cover and the illuminating area of the panel light are decreased.

### SUMMARY

A purpose of the present disclosure is to provide a lamp assembly and a frameless panel light to solve the problem which the prior art encounters. That is, the peripheral dark area is effectively decreased, an improved optical grade is achieved, and therefore, a light uniformity of the whole lamp cover and the illuminating area of the panel light are increased.

In some embodiments, a frameless panel light includes a lamp cover and a light source module. The lamp cover includes a front portion and a plurality of side portions. The side portions surround and adjoin the front portion. The front portion and the side portions define an accommodating space. The light source module is disposed in the accommodating space. The light source module includes a light source and a light guide plate optically coupled to the light source. The light guide plate includes a light-transmissive substrate and a microstructure. The light-transmissive substrate includes first and second major surfaces and a side surface connecting the first and second major surfaces. The microstructure is formed on the first major surface. The microstructure includes a recess and an annular groove around the recess. The annular groove has a depth greater than a depth of the recess. A bottom of the recess is at higher elevation than the first major surface from the second major surface. The annular groove has a protruding portion protruding from a bottom of the annular groove.

In some embodiments, the frameless panel light further includes at least a frame bar disposed in the accommodating space and fixed to the light source module and one of the side portions. The front portion and the light source module are separated by a light traveling space. The light traveling space exposes the front portion, each of the side portions and each joint between the side portions and the front portion, so that light of the light source module can reach the front portion, each of the side portions and the joint between the side portions and the front portion.

In some embodiments, the frame bar includes a base configured to support the light source, a supporting portion connected to a side of the base and supporting the light guide plate and the lamp cover, a positioning member disposed on one side of the supporting portion opposite to the light guide plate, and an engaging portion connected to another side of the base. The light guide plate is fixed between the engaging portion and the supporting portion. The light traveling space is between the engaging portion and the front portion.

In some embodiments, the bottom of the recess is at higher elevation than the bottom of the annular groove.

In some embodiments, a distribution density of a plurality of the microstructures increases as a distance increases from the side surface.

In some embodiments, the front portion of the lamp cover includes an anti-glare optical microstructure pattern.

In some embodiments, the lamp cover is a diffuser sheet.

In some embodiments, the bottom of the annular groove is at lower elevation than the first major surface from the second major surface.

In some embodiments, the bottom of the recess is at higher elevation than the bottom of the annular groove.

In some embodiments, the microstructure further comprises a convex surface protruding in a direction away from the second major surface, and the convex surface is at higher elevation than the first major surface from the second major surface.

In some embodiments, the convex surface connects a sidewall of the recess and a sidewall of the annular groove.

In some embodiments, a lamp assembly includes at least one connecting component; and a plurality of frameless panel lights. Any adjacent two of the frameless panel lights are arranged in a side-by-side manner and assembled together to provide a single planar light source. Each of the frameless panel lights includes a lamp cover and a light source module. The lamp cover includes a front portion and a plurality of side portions. The side portions surround and adjoin the front portion. The front portion and the side portions define an accommodating space. The light source module is disposed in the accommodating space. The light source module includes a light source and a light guide plate optically coupled to the light source. The light guide plate includes a light-transmissive substrate including first and second major surfaces and a side surface connecting the first and second major surfaces and a microstructure formed on the first major surface. The microstructure includes a recess and an annular groove around the recess. The annular groove has a depth greater than a depth of the recess. A bottom of the recess is at higher elevation than the first major surface from the second major surface. The annular groove has a protruding portion protruding from a bottom of the annular groove.

In some embodiments, the lamp assembly further includes at least a frame bar disposed in the accommodating space and fixed to the light source module and one of the side portions. The front portion and the light source module define a light traveling space therebetween. The light traveling space exposes the front portion, each of the side portions and each joint of the side portions and the front portion, so that light of the light source module can reach the front portion, each of the side portions and each joint of the side portions and the front portion unobstructedly.

In some embodiments, the frame bar includes a base configured to support the light source, a supporting portion connected to one side of the base and supporting the light guide plate and the lamp cover, a positioning member disposed on another side of the supporting portion opposite to the light guide plate, and an engaging portion connected to another side of the base. The light guide plate is fixed between the engaging portion and the supporting portion. The light traveling space is between the engaging portion and the front portion.

In some embodiments, a plurality of the microstructures are distributed on the first major surface in a random order.

In some embodiments, the front portion of the lamp cover includes an anti-glare optical microstructure pattern.

In some embodiments, the lamp cover is a diffuser sheet.

In some embodiments, the microstructure further includes a convex surface protruding in a direction away from the second major surface. The convex surface is at higher elevation than the first major surface from the second major surface.

In some embodiments, the microstructure further includes a protrusion protruding in the direction away from the second major surface. The protrusion connects the annular groove and the first major surface.

In some embodiments, the protrusion has curvature greater than curvature of the convex surface.

It is to be understood that both the foregoing general description and the following detailed description are by examples, and are intended to provide further explanation of the disclosure as claimed.

### BRIEF DESCRIPTION OF THE DRAWINGS

Embodiments of the present disclosure can be more fully understood by reading the following detailed description of the embodiments, with reference made to the accompanying drawings as follows.

FIG. 1 is a perspective view of a frameless panel light in accordance with some embodiments of the present disclosure;

FIG. 2 is a fragmentary exploded view of the frameless panel light shown in FIG. 1;

FIG. 3 is a fragmentary cross-sectional view taken along line A-A in FIG. 1;

FIG. 4 is a cross-sectional view of a light guide plate in accordance with some embodiments of the present disclosure;

FIG. 5 is an enlarged view of one microstructure shown in FIG. 4;

FIG. 6 is an enlarged fragmentary view of a mold core that implements fabrication of the light guide plate in accordance with some embodiments of the present disclosure;

FIG. 7 is a top view of a light guide plate in accordance with some embodiments of the present disclosure;

FIG. 8 is a top view of a light guide plate in accordance with some embodiments of the present disclosure;

FIG. 9 is a cross-sectional view of an edge light source module in accordance with some embodiments of the present disclosure;

FIG. 10 is a cross-sectional view of a direct back light source module in accordance with some embodiments of the present disclosure;

FIG. 11 is an enlarged cross-sectional view of a partial region M in FIG. 3;

FIG. 12 is a front view of a lamp assembly in accordance with some embodiments of the present disclosure;

FIG. 13 is a fragmentary cross-sectional view taken along line B-B in FIG. 12; and

FIG. 14 is an application schematic view of FIG. 12.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

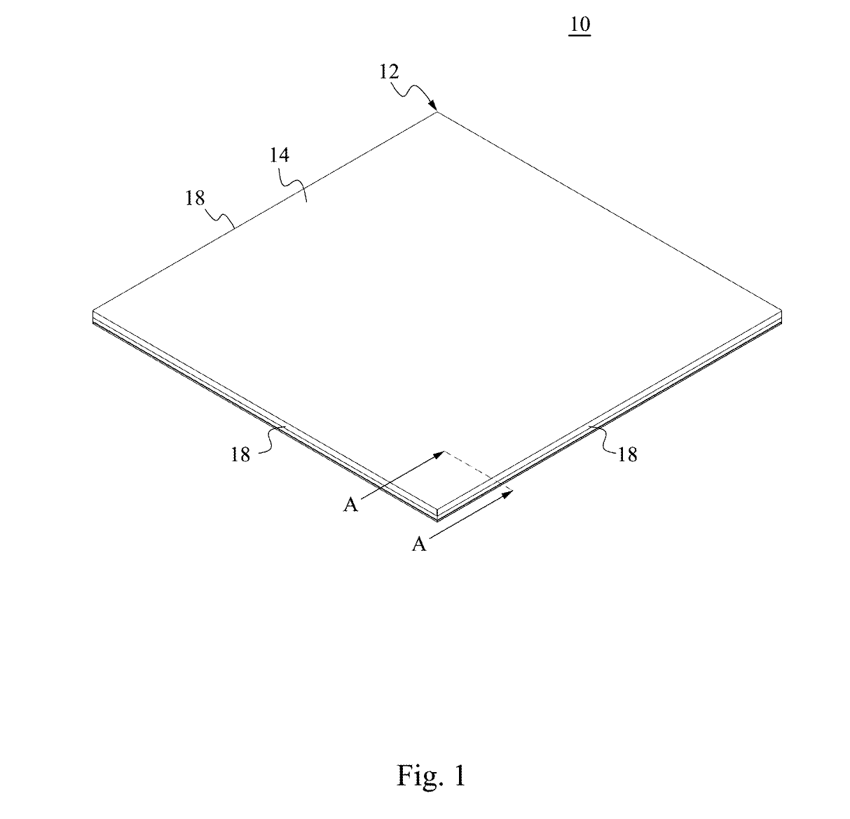

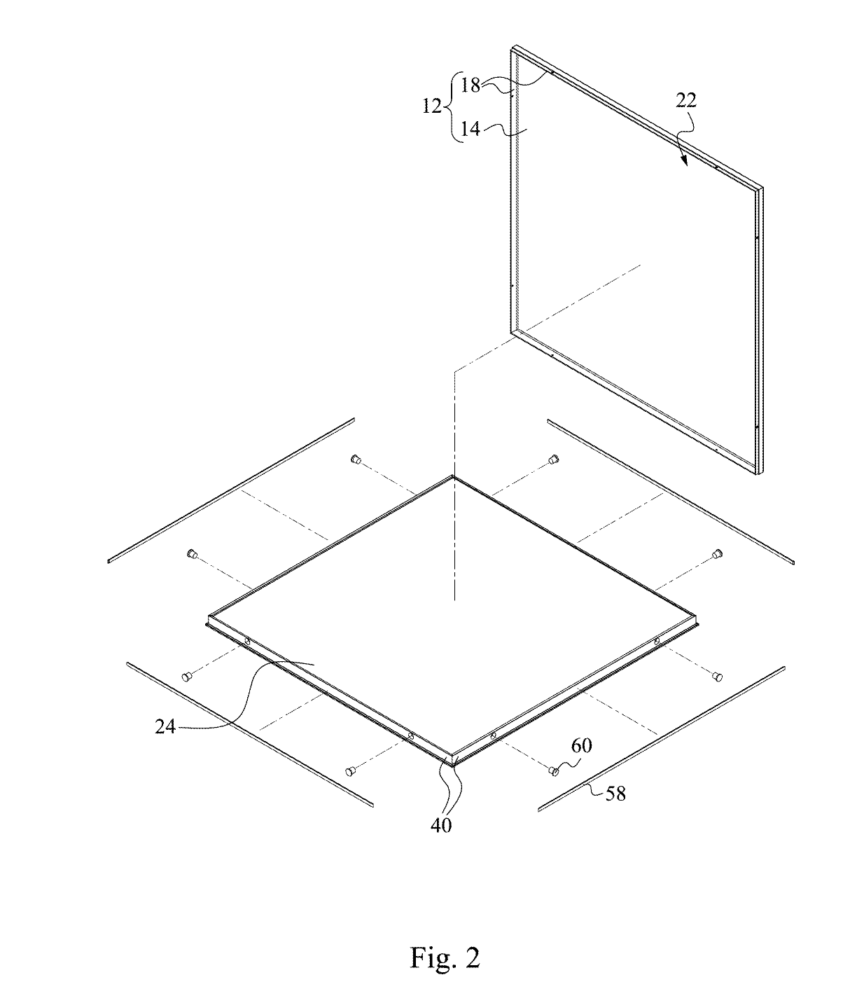

FIG. 1 illustrates a perspective view of a frameless panel light 10 in accordance with some embodiments of the present disclosure. FIG. 2 illustrates a fragmentary exploded view of the frameless panel light 10 in FIG. 1. With reference to FIGS. 1 and 2, the frameless panel light 10 includes a lamp cover 12, a light source module 24 and a plurality of frame bars 40. The lamp cover 12 includes a front portion 14 and a plurality of side portions 18. The side portions 18 surround and adjoin the front portion 14. The front portion 14 and the side portions 18 define an accommodating space 22. The light source module 24 is disposed in the accommodating space 22. Each frame bar 40 is disposed in the accommodating space 22 and fixed on the light source module 24 and one of the side portions 18 of the lamp cover 12.

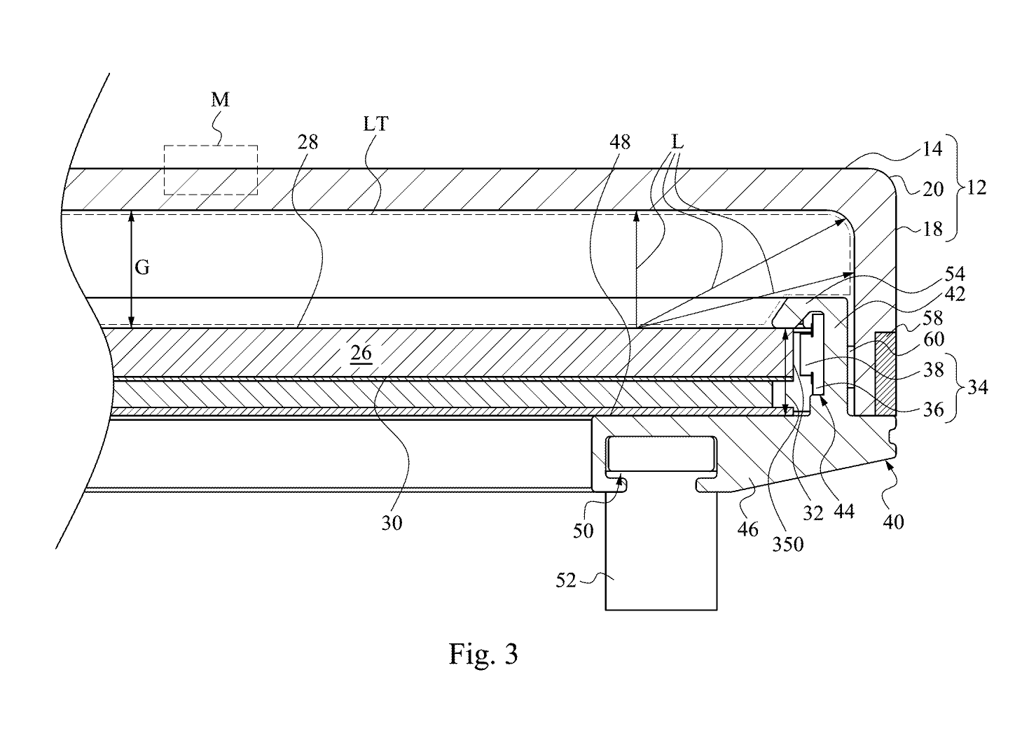

FIG. 3 illustrates a fragmentary cross-sectional view taken along line A-A in FIG. 1. With reference to FIGS. 2 and 3, the lamp cover 12 and the light source module 24 are separated from each other by a light travelling space LT, so that the light traveling space LT exposes the front portion 14, each side portion 18 and each joint 20 between the side portion 18 and front portion 14. In some embodiments, the light traveling space LT is further defined by the front portion 14, all side portions 18, each joint 20 between the side portion 18 and the front portion 14, the frame bar 40 and a light outgoing surface of a light guide plate 26.

Because the above-mentioned light traveling space LT is defined between the light source module 24 and the front portion 14 and each side portion 18 of the lamp cover 12, when the light source module emits light, the light L of the light source module can reach the front portion 14, each side portion 18 and each joint 20 between the side portion 18 and the front portion 14 unobstructedly. Therefore, brightness of each joint 20 between the side portion 18 and the front portion 14 is improved, a peripheral dark region is effectively reduced, and an improved optical performance is achieved, which in turn will improve brightness uniformity of the lamp cover 12 and an illumination area of the panel light. For example, when the lamp cover 12 is rectangular, the front portion 14, the four side portions 18 and each joint 20 between the side portion 18 and the front portion 14 can be illuminated sufficiently.

It is understood that in the present embodiments, the above-mentioned light traveling space LT between the lamp cover 12 and the light source module 24 is an air gap layer free from any physical structure, but the present disclosure is not limited in this regard. In other embodiments, as long as a luminous intensity standard is satisfied, the above-mentioned light traveling space can include light transmissive materials.

In the present embodiments, the light source module 24 includes a light guide plate 26 and a light bar 34. In some embodiments, the light bar 34 can be equivalently referred to as a light source. The light guide plate 26 is fixed on the frame bar 40 and has a light outgoing surface and a light incident surface. The light bar 34 is fixed on the frame bar 40 and configured to emit light toward the light incident surface. In particular, the light guide plate 26, such as a rectangular plate with a uniform thickness or a wedge with a decreasing thickness, has a front surface 28, a rear surface 30 opposite to the front surface 28, and four side surfaces 32 surrounding the front surface 28 and the rear surface 30. The front surface 28 or the rear surface 30 has an area greater than an area of any one of the side surfaces 32. The front surface 28 of the light guide plate 26 can serve as the aforementioned light outgoing surface of the light guide plate 26. Any one of the side surfaces 32 of the light guide plate 26 can serve as the aforementioned light incident surface. The light bar 34 faces toward one of the side surfaces 32 (i.e., the light incident surface) of the light guide plate 26. The light bar 34 includes at least one circuit board 36 and a plurality of light emitting diodes (LED) 38. The light emitting diodes 38 are arranged linearly and fixed on the circuit board 36. The light emitting diodes 38 face the aforementioned light incident surface and emit light toward the light incident surface. The circuit board 36 can be, for example, a printed circuit board (PCB), a metal core printed circuit board (MCPCB), or a flexible printed circuit board (FPC).

In some embodiments, a spacing G between the front portion 14 and the front surface 28 of the light guide plate 26 is in a range from 1.5 mm to 20 mm. That is, a shortest distance between the inner surface of the front portion 14 and the front surface 28 of the light guide plate 26 is in a range from 1.5 mm to 20 mm, but the present disclosure is not limited in this regard. In other embodiments, the spacing between the front portion and the front surface of the light guide plate may be greater than 20 mm.

In the present embodiments, the frame bar 40 includes a base 42, a supporting portion 46, a positioning member 50 and an engaging portion 54. The base 42 is configured to support the light bar 34. The supporting portion 46 is connected to a side of the base 42 and is configured to support the light guide plate 26 and the lamp cover 12. The engaging portion 54 is connected to another side of the base 42 such that the light guide plate 26 is fixed between the engaging portion 54 and the supporting portion 46. The light traveling space LT is between the engaging portion 54 and the front portion 14. The positioning member 50 is disposed on a surface of the supporting portion 46 which is opposite to the base 42 and is configured to hold at least one support 52, so as to be suspended from a wall or a ceiling by the support 52. For example, the supporting portion 46 includes a supporting surface 48 configured to support the light guide plate 26 and the side portion 18 of the lamp cover 12. The base 42 stands on the supporting surface 48 of the supporting portion 46 and is disposed between the side portion 18 and the light guide plate 26. A clamping space 350 is defined between the supporting portion 46 and the engaging portion 54. Therefore, when the light guide plate 26 is fixed between the engaging portion 54 and the supporting portion 46, the side surface 32 of the light guide plate 26 is in the clamping space 350. A base 42 of one of the frame bars 40 has a slot 44 communicating the clamping space 350 such that the light bar 34 can be inserted in the slot 44.

In the present embodiments, the frame bars 40 include metal and are formed using a punching process or a continuous extrusion process (e.g., an aluminum extrusion frame bar), but the present disclosure is not limited in this regard.

In the present embodiments, the lamp cover 12 is a diffuser sheet, such as an integrated cover diffuser sheet. The diffuser sheet has a transmittance of 57%, a haze of 99% and a thickness of 3 mm, but the present disclosure is not limited in this regard.

In the present embodiments, the lamp cover 12 is locked on each frame bar 40 by bolts 60. After the bolts 60 lock the lamp cover 12 to each frame bar 40, an outer surface of the lamp cover 12 facing away from the frame bar 40 is covered by a plate 58, such that the bolts 60 on the lamp cover 12 are covered.

In some embodiments, the light guide plate 26 may include various geometries for improving device performance, which will be discussed in detail below.

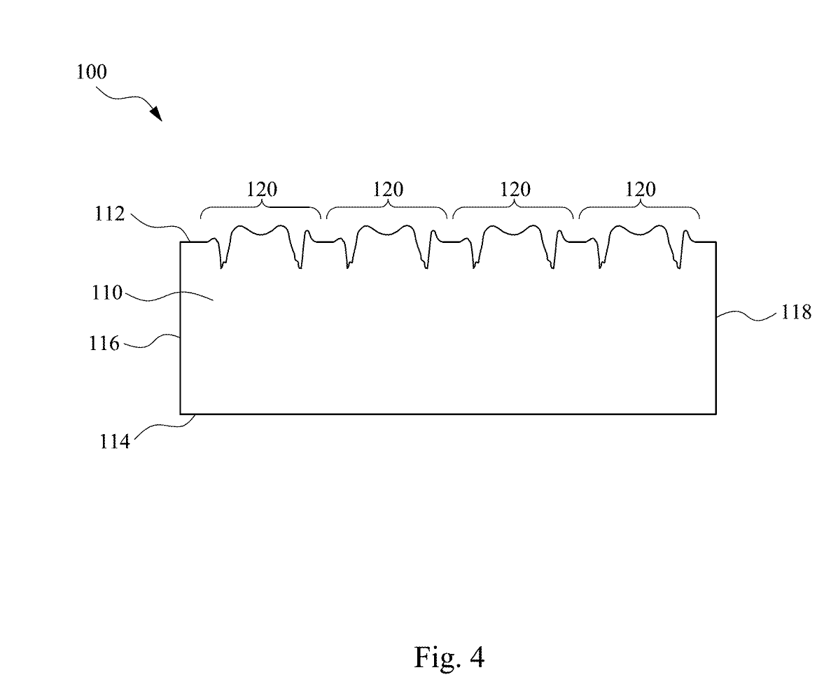

FIG. 4 is a cross-sectional view of a light guide plate 100 in accordance with some embodiments of the present disclosure. As illustrated, the light guide plate 100 includes a light-transmissive substrate 110 having first and second major surfaces 112, 114 and side surfaces 116, 118. The side surface 116 connects a first side (e.g., left side as illustrated) of the first major surface 112 and a first side (e.g., left side as illustrated) of the second major surface 114. The side surface 118 connects a second side (e.g., right side as illustrated) of the first major surface 112 and a second side (e.g., right side as illustrated) of the second major surface 114. In some embodiments, the first major surface 112 can be equivalently referred to as the light outgoing surface of the light guide plate 100. The light guide plate 100 further includes one or more microstructures 120 formed on the first major surface 112. In the illustration, these microstructures 120 have different cross-sectional contours than that of the smooth first major surface 112, and hence the microstructures 120 may scatter light traveling there-through, which in turn will provide a desired light distribution to a display panel (not shown) disposed over the light guide plate 100.

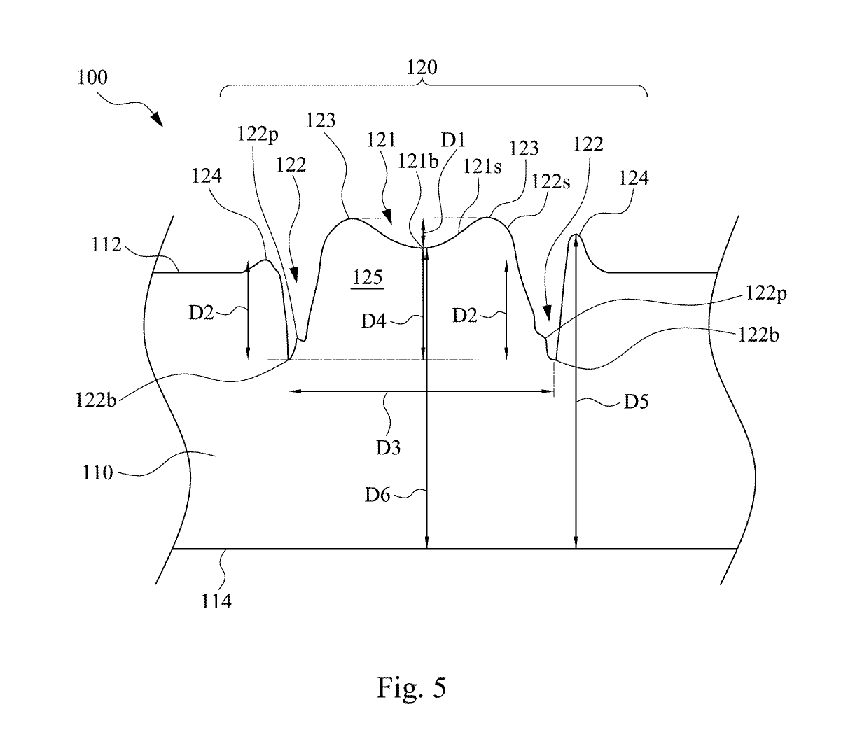

Referring to FIG. 5, illustrated is an enlarged view of a microstructure 120 shown in FIG. 4. The microstructure 120 includes a recess 121 and an annular groove 122 around (i.e., encircling) the recess 121. The annular groove 122 is deeper than the recess 121. For example, the recess 121 has a depth D1 measured along a vertical direction (e.g., a direction from the first major surface 112 to the second major surface 114), the annular groove 122 has a depth D2 measured along the vertical direction, and the depth D2 of the annular groove 122 is greater than the depth D1 of the recess 121. Moreover, a bottom 121b of the recess 121 is at a position higher than the first major surface 112. Stated in another way, the bottom 121b of the recess 121 is at higher elevation than the first major surface 112 from the second major surface 114. Such geometry as discussed above may be advantageous to achieve a desired light distribution.

Moreover, in some embodiments, a bottom 122b of the annular groove 122 is at a position lower than the bottom 121b of the recess 121. In other words, the bottom 121b of the recess 121 is at higher elevation than the bottom 122b of the annular groove 122 from the second major surface 114. In further embodiments, the bottom 122b of the annular groove 122 is at a position lower than the first major surface 112. Stated differently, the bottom 122b of the annular groove 122 is at lower elevation than the first major surface 112 from the second major surface 114. In some embodiments, the annular groove 122 has a protruding portion 122p protruding from the bottom 122b of the annular groove 122.

In some embodiments, the bottom 122b of the annular groove 122 is curved more than the recess 121. For example, the bottom 122b of the annular groove 122 has curvature greater than the recess 121. Stated in another way, the bottom 122b of the annular groove 122 has a curvature radius less than a curvature radius of the recess 121.

In some embodiments, the microstructure 120 further includes a convex surface 123 around the recess 121. The convex surface 123 protrudes in a direction away from the second major surface 114 and extends in a circular direction to encircle the recess 121. The convex surface 123 is at higher elevation than the first major surface 112 from the second major surface 114. The convex surface 123 connects a sidewall 121s of the recess 121 and a sidewall 122s of the annular groove 122. The convex surface 123 has a smooth convex contour in a cross-sectional view as illustrated in FIG. 4, which indicates that a top of the convex surface 123 has a zero slope. In some embodiments, the recess 122 has a smooth concave contour in a cross-sectional view as illustrated in FIG. 4, which indicates that the bottom 121b of the recess 121 has a zero slope.

In some embodiments, the microstructure 120 further includes a protrusion 124 around the annular groove 122. The protrusion 124 protrudes in a direction substantially the same as that the convex surface 123 protrudes in. For example, the protrusion 124 protrudes in the direction away from the second major surface 114 and extends in a circular direction to encircle the annular groove 122. Thus, the protrusion 124 connects the annular groove 122 and the first major surface 112.

In some embodiments, the protrusion 124 has a smooth convex contour in a cross-sectional view as illustrated in FIG. 5, which indicates that a top of the protrusion 124 has a zero slope. In some embodiments, the protrusion 124 is curved more than the convex surface 123. For example, the protrusion 124 has curvature greater than curvature of the convex surface 123. Stated differently, the protrusion 124 has a curvature radius less than a curvature radius of the convex surface 123.

In some embodiments, the protrusion 124, the annular groove 122, the convex surface 123 and the recess 121 are arranged in a concentric fashion. A structure encircled by the annular groove 122 is also referred to as a spherical protrusion 125 that protrudes from the annular groove 122. The recess 121 is recessed from a top of the spherical protrusion 125.

In some embodiments, the protrusion 124 is at a position higher than the first major surface 112. Stated in another way, the protrusion 124 is at higher elevation than the first major surface 112 from the second major surface 114. In further embodiments, the protrusion 124 is at a position lower than the convex surface 123. In other words, the protrusion 124 is at lower elevation than the convex surface 123 from the second major surface 114.

In some embodiments, the depth D1 of the recess 121 ranges from about 1.5 um to about 2.1 um. For example, the depth D1 of the recess 121 is about 1.8 um. In some embodiments, the depth D2 of the annular groove 122 ranges from about 2.5 um to about 3.5 um. For example, the depth D2 of the annular groove 122 is about 3 um. In some embodiments, two bottoms 122b of the annular groove 122 geometrically farthest away from each other are separated by a distance D3, which is in a range from about 50 um to about 65 um. For example, the distance D3 separating opposite bottoms 122b of the annular groove is about 57 um. In some embodiments, the bottom 121b of the recess 121 and the bottom 122b of the annular groove 122 are separated by a vertical distance D4, which is in a range from about 2.5 um to about 3.7 um. For example, the vertical distance D4 separating bottoms 121b and 122b of the recess 121 and annular groove 122 is about 3.1 um. In some embodiments, the top of the protrusion 124 and the second major surface 114 are separated by a vertical distance D5, which is in a range from about 1.981 mm to about 2.021 mm. For example, the vertical distance D5 separating the top of the protrusion 124 and the second major surface 114 is about 2.001 mm. In some embodiments, the bottom 121b of the recess 121 and the second major surface 114 are separated by a vertical distance D6, which is in a range from about 1.981 mm to about 2.021 mm. For example, the vertical distance D6 separating the bottom 121b of the recess 121 and the second major surface 114 is about 2.001 mm.

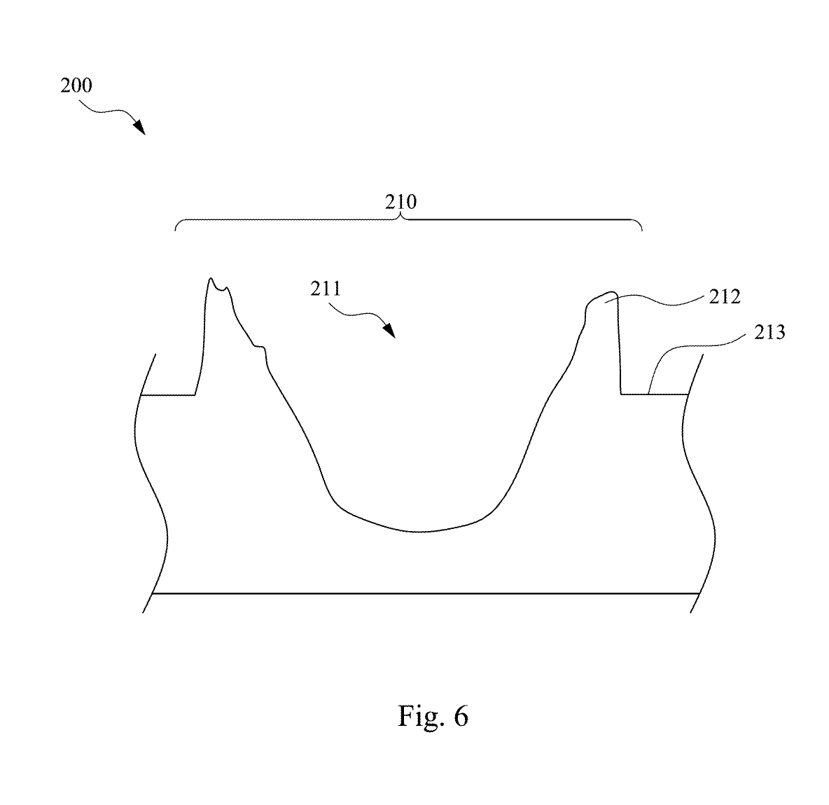

One or more geometries of the microstructure 120 as discussed above are advantageous for achieving a desired light distribution provided by light guide plate 100. Fabrication of the light guide plate 100 having one or more microstructures 120 as discussed above is described below with reference to FIG. 6, which illustrates an enlarged fragmentary view of a mold core 200 that implements the fabrication of the light guide plate 100. Formation of the mold core 200 includes forming one or more microstructures 210 on a surface 213 of the mold core 200 using a laser process. The microstructure 210 has a recess 211 and a ring 212 around the recess 211 and protruding from the surface 213 of the mold core 200. The recess 211 has a smooth surface not less than half a total surface of the recess 211. The light guide plate 100 can be thermoformed using the mold core 200 with the one or more microstructures 210. Conditions of the thermoforming process using the mold core 200 with the microstructure(s) 210 is advantageous for forming the light guide plate 100 with the microstructure(s) 120 with desired geometry as discussed above by using a thermoforming process. As a result, the light guide plate 100 capable of generating a desired light distribution can be fabricated using the mold core 200. In some embodiments, the thermoforming process is performed at a temperature in a range from about 50 degrees Celsius to about 150 degrees Celsius. If the thermoforming process is performed at a temperature higher than 150 degrees Celsius, the cooling time will increase and even cause the light guide plate curved during cooling process. If the thermoforming process is performed at a temperature lower than 50 degrees Celsius, the microstructure is unable to stamp to the surface of the light guide plate.

For example, the laser process for forming the microstructure 210 is carried out via a neodymium-doped yttrium aluminum garnet laser (Nd—YAG) or the like. The wavelength of the laser ranges from about 900 nanometers to about 1800 nanometers. The laser is focused on the mold core 200, rapidly increasing a temperature of the focus point. As a result, the mold core 200 material at the focus point disintegrates due to high temperature oxidation, thus forming the spherical recess 211. During the laser process, the mold core 200 material around the focus point is melted, which in turn forms the ring 212 enclosing the spherical recess 211.

After formation of the mold core 200, the light guide plate 100 can be molded in a mold having the mold core 200 using a thermoforming process. The spherical protrusion 125 is formed on the light guide plate 100 corresponding to the spherical recess 211 of the mold core 200, and the annular groove 122 are defined in the light guide plate 100 corresponding to the ring 212 of the mold core 200. The recess 121 of the spherical protrusion 125 may be formed because of air gap between the mold core 200 and the material of the light guide plate 100 during the thermoforming process.

The light guide plate 100 may be made from a material such as polycarbonate, polymethyl methacrylate, polystyrene, copolymer of methylmethacrylate and styrene, the like, or combinations thereof. In alternative embodiments, the laser process may be implemented by ruby laser, alexandrite laser, and so on. The wavelength of the laser may also be selected from other desired values, such as 266 nanometers, 355 nanometers, 532 nanometers, and so on.

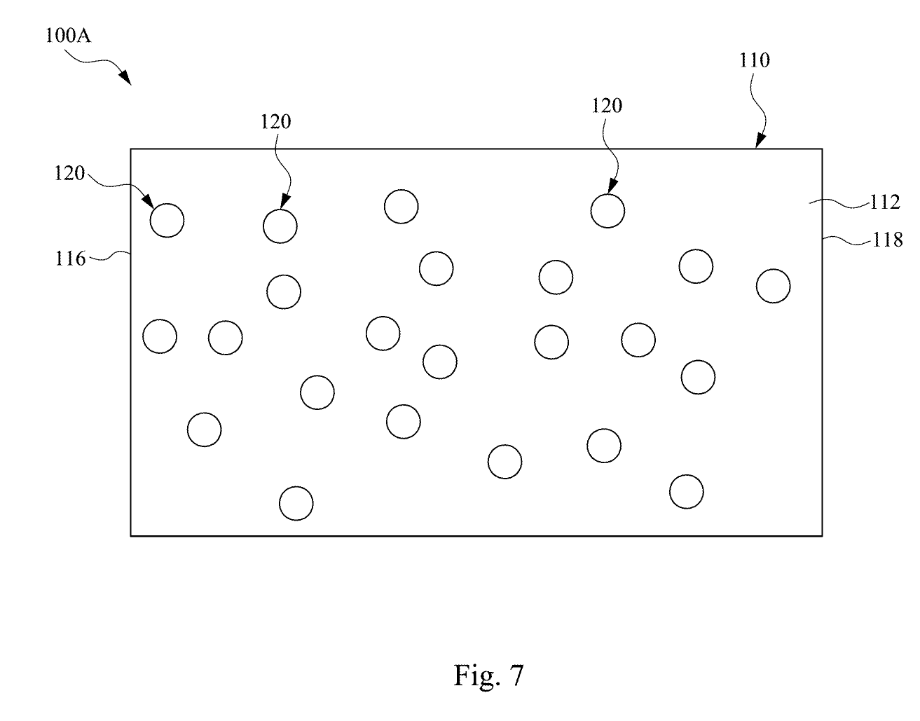

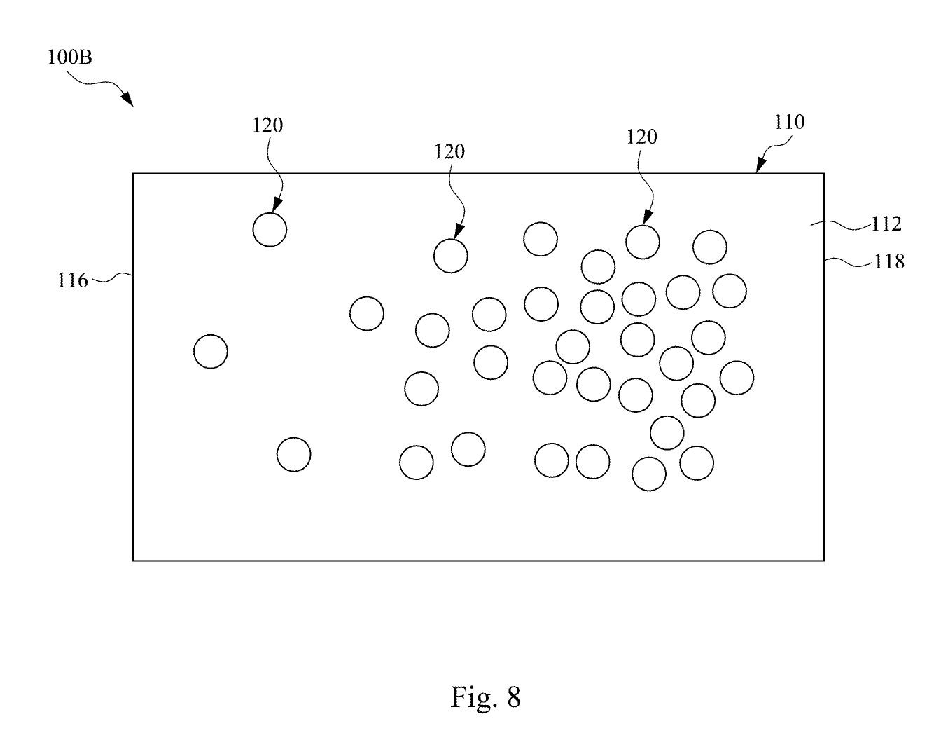

Microstructures 120 can be distributed in various fashions. For example, referring now to FIG. 7, illustrated is a light guide plate 100A including numerous microstructures 120 distributed on the first major surface 112 of the light-transmissive substrate 110 in a random order. Stated in another way, a distance between any neighboring two microstructures 120 is irregular rather than following a regular order. Referring now to FIG. 8, illustrated is another light guide plate 100B including numerous microstructures 120 distributed in a different fashion than that of the light guide plate 100A. For example, the microstructures 120 are distributed as a function of a distance from one side surface (e.g., the side surface 116) of the light-transmissive substrate 110. Stated differently, the distribution density of the microstructures 120 is related of the distance from the side surface 116. In further embodiments, as illustrated in FIG. 8, the distribution density of the microstructures 120 increases as a distance increases from the side surface 116. Such a distribution of microstructures 120 may be beneficial in providing more uniform light distribution, if the light guide plate 100B is employed in an edge-type back light module where a light source is disposed proximate the side surface 116. This is due to the fact that light flux decreases as a distance from the side surface 116 increases.

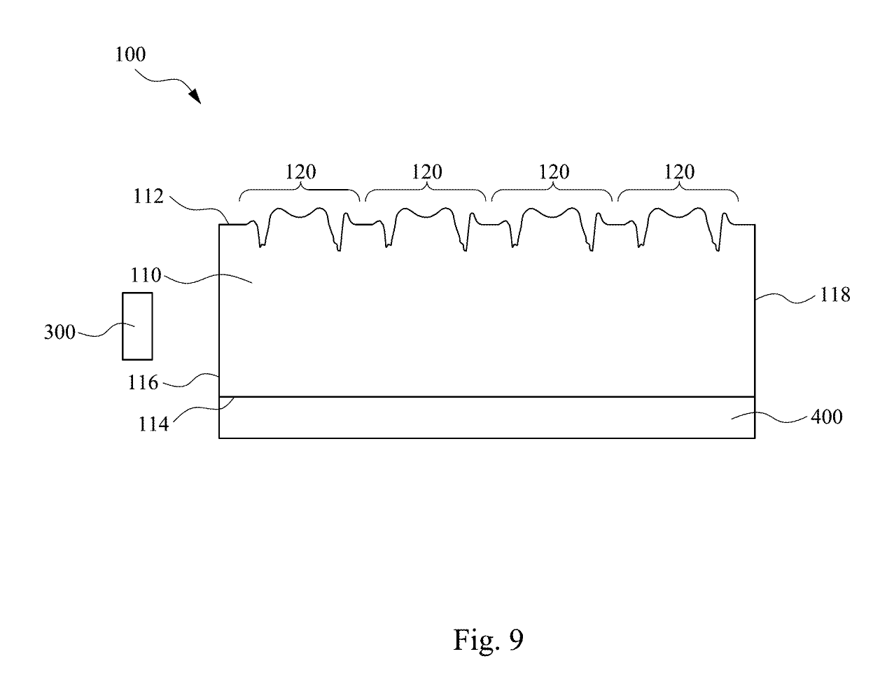

The light guide plate(s) as discussed above can be employed in any of a variety of light source modules (e.g., the light source module 24 as shown in FIG. 2). For example, referring to FIG. 9, illustrated is a light source module including the light guide plate 100, a light source 300 and a reflective feature 400. The light guide plate 100 is optically coupled to the light source 300 through the side surface 116. The term “optically coupled” as used herein refers to coupling such that light from one element is imparted to another element. In the illustration, the light source 300 is disposed adjacent to the side surface 116 of the light-transmissive substrate 110, and the reflective feature 400 is disposed adjacent to the second major surface 114 of the light-transmissive substrate 110. In this way, the light source 300 can emit light into the light guide plate 100 through the side surface 116, and the light traveling within the light guide plate 100 can be reflected toward the microstructures 120 by the reflective feature 400. Thus, the microstructures 120 can scatter the light toward an overlying display panel (not shown). In this case, the light source module as illustrated in FIG. 9 can be equivalently referred to as an edge-type back light module. In some embodiments, the microstructures 120 are upright over the reflective feature 400, which in turn will benefit scattering the light. In some embodiments, an additional reflective feature (not shown) is disposed adjacent to the side surface 118 to confine light in the light guide plate 100. In some embodiments, a light guide plate according to other embodiments (e.g., the light guide plate 100A or 100B) can be employed in place of the light guide plate 100.

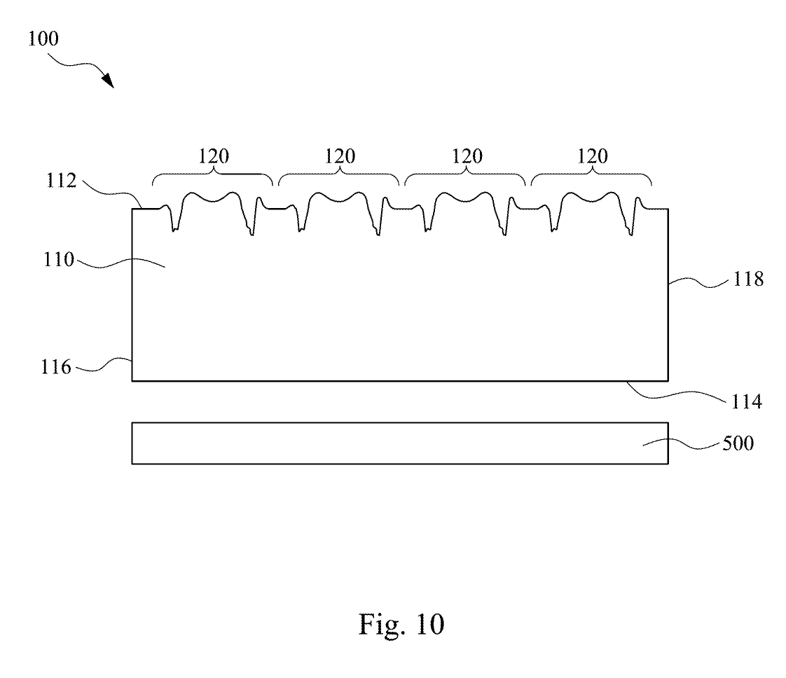

Referring to FIG. 10, illustrated is another light source module different from the light source module illustrated in FIG. 9. The light source module as illustrated in FIG. 10 includes the light guide plate 100 and a light source 500 disposed adjacent to the second major surface 114 of the light-transmissive substrate 110. For example, the second major surface 114 is between the light source 500 and the microstructures 120. In this way, the light emitted from the light source 500 travels into the light-transmissive substrate 110 and toward the microstructures 120 through the second major surface 114. Thus, the microstructures 120 can scatter the light toward an overlying display panel (not shown). In this case, the light source module as illustrated in FIG. 10 can serve as either an illumination module or a direct-type backlight module. In some embodiments, additional reflective features (not shown) are respectively disposed adjacent to the side surfaces 116 and 118 to confine light in the light guide plate 100. In some embodiments, a light guide plate according to other embodiments (e.g., the light guide plate 100A or 100B) can be employed in place of the light guide plate 100.

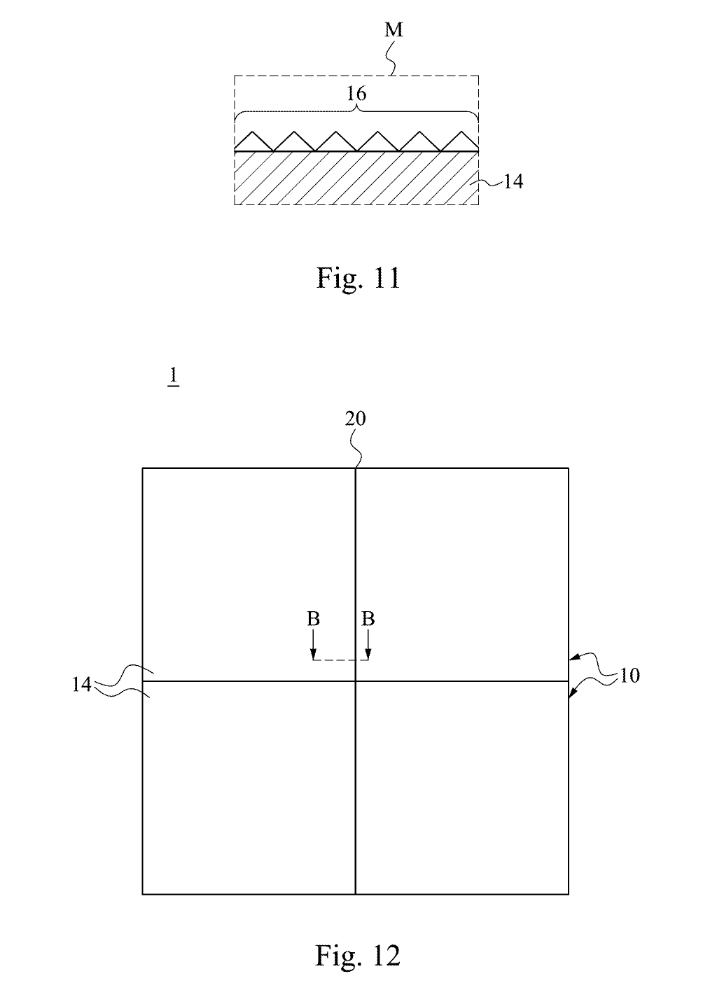

FIG. 11 illustrates an enlarged cross-sectional view of a partial region M in FIG. 3. As shown in FIGS. 3 and 11, in the present embodiments, the front portion 14 of the lamp cover 12 further includes an optical microstructure pattern 16 and is configured to improve an optical performance, such as the light outgoing effectiveness and uniformity. For example, the optical microstructure pattern is an anti-glare optical microstructure pattern. Therefore, when light penetrates through the lamp cover, a decreased glare rating (e.g., less than a unified glare rating (UGR) of 19) is achieved by using guidance of the anti-glare optical microstructure pattern, which in turn will result in reduced glare.

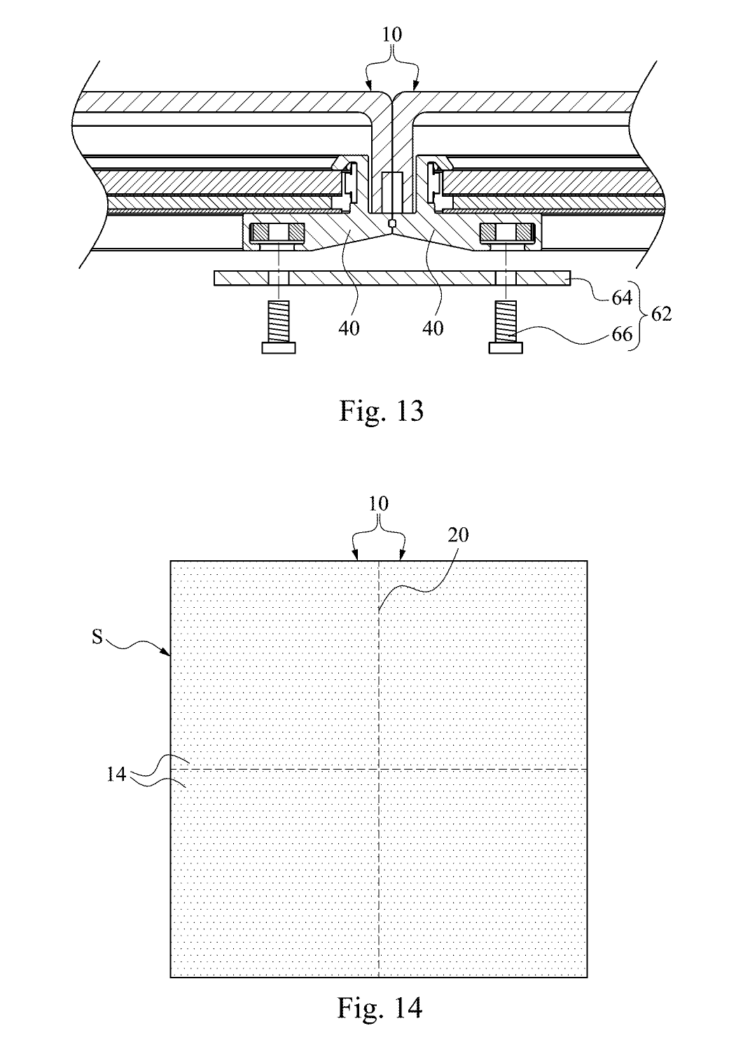

In the present embodiments, FIG. 12 illustrates a top view of the lamp assembly 1 in accordance with some embodiments of the present disclosure. FIG. 13 illustrates a fragmentary cross-sectional view taken along line B-B in FIG. 12. As shown in FIGS. 12 and 13, the lamp assembly 1 includes a plurality of aforementioned frameless panel lights 10 (e.g., four panel lights) and connecting components 62. Any adjacent two of the frameless panel lights 10 are arranged in a side-by-side manner and connected using at least one of the connecting components 62. When the frameless panel lights 10 are assembled together, the frameless panel lights 10 are arranged in a side-by-side manner and fixed together.

For example, the connecting components 62 include a connecting portion 64 and a plurality of bolts 66. The connecting portion 64 is locked on frame bars 40 of any adjacent two of the frameless panel lights 10 by the bolts 66, such that the frameless panel lights 10 can be arranged side by side steady and spliced into one piece, but the present disclosure is not limited in this regard. Other conventional fixing methods can be used for fixing the frameless panel lights.

FIG. 14 illustrates a schematic view of operating the lamp assembly 1 as shown in FIG. 12. As shown in FIG. 14, when the lamp assembly 1 emits light, peripheral edges of each frameless panel light 10 (that is, the joint 20 between the front portion and the side portion) can be illuminated sufficiently such that no apparent dark zone is present between the frameless panel lights 10. Therefore, the frameless panel lights 10 are integrated into a single planar light source S and hence improved aesthetic quality is achieved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A frameless panel light, comprising:
a lamp cover including a front portion and a plurality of side portions, the side portions surrounding and adjoining the front portion, the front portion and the side portions defining an accommodating space; and
a light source module disposed in the accommodating space, the light source module comprising:
a light source; and
a light guide plate optically coupled to the light source, the light guide plate comprising:
a light-transmissive substrate comprising first and second major surfaces and a side surface connecting the first and second major surfaces; and
a microstructure formed on the first major surface, wherein the microstructure comprises a recess and an annular groove around the recess, the annular groove has a depth greater than a depth of the recess, and a bottom of the recess is at higher elevation than the first major surface from the second major surface, and the annular groove has a protruding portion protruding from a bottom of the annular groove.

2. The frameless panel light of claim 1, further comprising:
at least a frame bar disposed in the accommodating space and fixed to the light source module and one of the side portions,
wherein the front portion and the light source module are separated by a light traveling space, the light traveling space exposes the front portion, each of the side portions and each joint between the side portions and the front portion, so that light of the light source module can reach the front portion, each of the side portions and the joint between the side portions and the front portion.

3. The frameless panel light of claim 2, wherein the frame bar comprises:
a base configured to support the light source;
a supporting portion connected to a side of the base and supporting the light guide plate and the lamp cover;
a positioning member disposed on one side of the supporting portion opposite to the light guide plate; and
an engaging portion connected to another side of the base, wherein the light guide plate is fixed between the engaging portion and the supporting portion, and wherein the light traveling space is between the engaging portion and the front portion.

4. The frameless panel light of claim 1, wherein the bottom of the recess is at higher elevation than the bottom of the annular groove.

5. The frameless panel light of claim 1, wherein a distribution density of a plurality of the microstructures increases as a distance increases from the side surface.

6. The frameless panel light of claim 1, wherein the front portion of the lamp cover includes an anti-glare optical microstructure pattern.

7. The frameless panel light of claim 1, wherein the lamp cover is a diffuser sheet.

8. The frameless panel light of claim 1, wherein the bottom of the annular groove is at lower elevation than the first major surface from the second major surface.

9. The frameless panel light of claim 1, wherein the bottom of the recess is at higher elevation than the bottom of the annular groove.

10. The frameless panel light of claim 1, wherein the microstructure further comprises a convex surface protruding in a direction away from the second major surface, and the convex surface is at higher elevation than the first major surface from the second major surface.

11. The frameless panel light of claim 10, wherein the convex surface connects a sidewall of the recess and a sidewall of the annular groove.

12. A lamp assembly, comprising:
at least one connecting component; and
a plurality of frameless panel lights, any adjacent two of the frameless panel lights are arranged in a side-by-side manner and assembled together to provide a single planar light source, each of the frameless panel lights comprising:
a lamp cover including a front portion and a plurality of side portions, the side portions surrounding and adjoining the front portion, the front portion and the side portions defining an accommodating space; and
a light source module disposed in the accommodating space, the light source module comprising:
a light source; and
a light guide plate optically coupled to the light source, the light guide plate comprising:
a light-transmissive substrate comprising first and second major surfaces and a side surface connecting the first and second major surfaces; and
a microstructure formed on the first major surface, wherein the microstructure comprises a recess and an annular groove around the recess, the annular groove has a depth greater than a depth of the recess, and a bottom of the recess is at higher elevation than the first major surface from the second major surface, and the annular groove has a protruding portion protruding from a bottom of the annular groove.

13. The lamp assembly of claim 12, further comprising:
at least a frame bar disposed in the accommodating space and fixed to the light source module and one of the side portions,
wherein the front portion and the light source module define a light traveling space therebetween, the light traveling space exposes the front portion, each of the side portions and each joint of the side portions and the front portion, so that light of the light source module can reach the front portion, each of the side portions and each joint of the side portions and the front portion unobstructed.

14. The lamp assembly of claim 13, wherein the frame bar comprises:
a base configured to support the light source;
a supporting portion connected to one side of the base and supporting the light guide plate and the lamp cover;
a positioning member disposed on another side of the supporting portion opposite to the light guide plate; and
an engaging portion connected to another side of the base, wherein the light guide plate is fixed between the engaging portion and the supporting portion, and wherein the light traveling space is between the engaging portion and the front portion.

15. The lamp assembly of claim 12, wherein a plurality of the microstructures are distributed on the first major surface in a random order.

16. The lamp assembly of claim 12, wherein the front portion of the lamp cover includes an anti-glare optical microstructure pattern.

17. The lamp assembly of claim 12, wherein the lamp cover is a diffuser sheet.

18. The lamp assembly of claim 12, wherein the microstructure further comprises a convex surface protruding in a direction away from the second major surface, and the convex surface is at higher elevation than the first major surface from the second major surface.

19. The lamp assembly of claim 18, wherein the microstructure further comprises a protrusion protruding in the direction away from the second major surface, and the protrusion connects the annular groove and the first major surface.

20. The lamp assembly of claim 19, wherein the protrusion has curvature greater than curvature of the convex surface.
